(19) United States
(12) Patent Application Publication
(10) Pub. No.: US 2022/0193723 A1
(43) Pub. Date: Jun. 23, 2022

(54) ACOUSTIC PIEZOELECTRIC MEMBRANE TRANSDUCER ARRAYS WITH LOCALIZED MEMBRANE VIBRATIONS

(71) Applicant: Nederlandse Organisatie voor toegepast-natuurwetenschappelijk onderzoek TNO, 's-Gravenhage (NL)

(72) Inventors: Hylke Broer AKKERMAN, Rosmalen (NL); Albert Jos Jan Marie VAN BREEMEN, Eindhoven (NL); Gerwin Hermanus GELINCK, Valkenswaard (NL); Arthur Perry BERKHOFF, Doetinchem (NL); Paul Louis Maria Joseph VAN NEER, Bergschenhoek (NL); Arno Willem Frederik VOLKER, Delft (NL)

(21) Appl. No.: 17/605,437

(22) PCT Filed: Apr. 29, 2020
(86) PCT No.: PCT/NL2020/050265

§ 371 Date: Oct. 21, 2021

(30) Foreign Application Priority Data
Apr. 30, 2019 (EP) 19171943.4

(51) Int. Cl. B06B 1/06

(52) U.S. Cl. CPC B06B 1/0692; G08B 6/00

(57) ABSTRACT

An acoustic device (100) comprises an array of acoustic transducers (10a,10b) formed by a patterned stack (12-15) on a flexible substrate (11). The stack comprises a piezoelectric layer (13) sandwiched between respective bottom and top electrode layers (12,15), and a patterned insulation layer (14) formed by a pattern of insulation material (14m). The pattern comprises insulated areas (A14) where the insulation material (14m) is disposed between one of the electrodes (12,15) and the piezoelectric layer (13), and contact areas (A10) without the insulation material (14m) where both electrodes (12,15) contact the piezoelectric layer (13).

### TECHNICAL FIELD AND BACKGROUND

The present disclosure relates to an acoustic device with an array of acoustic transducers, and method of manufacturing.

Typically, when making an array of piezoelectric vibrating membranes on plastic for acoustic/ultrasound applications, the piezoelectric material is electrically poled at the location of the membranes by applying an electric field over the electrodes and, when operated, vibrations of the membrane preferably should not traverse laterally (plate waves) through the array and influence the neighboring devices. This acoustic crosstalk may negatively affects the quality of the produced acoustic field and its level leading e.g. to reduced image quality, a poorly defined measurement area, or a larger than expected focus for acoustic haptic feedback.

As background, US 2013/0293065 A1 describes piezoelectric micromachined ultrasonic transducer (pMUT) arrays. In one example, coupling strength within a population of transducer elements provides degenerate mode shapes that split for wide bandwidth total response while less coupling strength between adjacent element populations provides adequately low crosstalk between the element populations. In another example, differing membrane sizes within a population of transducer elements provides differing frequency response for wide bandwidth total response while layout of the differing membrane sizes between adjacent element populations provides adequately low crosstalk between the element populations. In another example, close packing of membranes within a population of transducer elements provides improved efficiency for the wide bandwidth embodiments. In another example, elliptical piezoelectric membranes provide multiple resonant modes for wide bandwidth total response and high efficiency while orthogonality of the semi-principal axes between adjacent element populations provides adequately low crosstalk between the element populations.

There remains a need for further improvement in the manufacturability and design freedom of acoustic devices having transducer arrays with minimal crosstalk.

### SUMMARY

Aspects of the present disclosure relate to an acoustic device and method of manufacturing the same. Preferably, the acoustic device comprises an array of acoustic transducers formed by a patterned stack on a flexible substrate. The stack comprises a piezoelectric layer sandwiched between respective bottom and top electrode layers. A patterned insulation layer is formed by a pattern of insulation material. The pattern comprises insulated areas where the insulation material is disposed between one of the electrodes and the piezoelectric layer, and contact areas without the insulation material where both electrodes contact the piezoelectric layer.

As will be appreciated, the insulation material may function as electrical insulation to divide or form the transducer array by electrically insulating contact between the electrode and the piezoelectric layer at the insulated areas around and between the transducers. In this way the array of acoustic transducers can be manufactured more easily. Furthermore, the insulation material may function as acoustic insulation between the transducers. In this way, acoustic interference or crosstalk can be alleviated.

### BRIEF DESCRIPTION OF DRAWINGS

These and other features, aspects, and advantages of the apparatus, systems and methods of the present disclosure will become better understood from the following description, appended claims, and accompanying drawing wherein:

FIG. 1A illustrates a cross-section view of adjacent acoustic transducers;

FIG. 1B illustrates further details of one of the transducers;

FIG. 2A illustrates a cross-section of an acoustic device wherein the insulation material is applied between the bottom electrode and the piezoelectric layer.

FIG. 2B illustrates a cross-section of an acoustic device with an intermediate protection layer;

FIGS. 3A-3D illustrate a method of manufacturing an acoustic device;

FIGS. 4A and 4B illustrate an acoustic device with the flexible substrate fixed to a support structure.

FIG. 5A illustrates a transducer array according to an example layout;

FIG. 5B shows a photograph of a device with similar layout;

FIG. 6 illustrates a measurement of deflection over a surface of an acoustic device, such as shown in FIG. 5B, where the transducers are actuated;

FIGS. 7A and 7B illustrate another layout of acoustic transducers.

### DESCRIPTION OF EMBODIMENTS

Terminology used for describing particular embodiments is not intended to be limiting of the invention. As used herein, the singular forms “a”, “an” and “the” are intended to include the plural forms as well, unless the context clearly indicates otherwise. The term “and/or” includes any and all combinations of one or more of the associated listed items. It will be understood that the terms “comprises” and/or “comprising” specify the presence of stated features but do not preclude the presence or addition of one or more other features. It will be further understood that when a particular step of a method is referred to as subsequent to another step, it can directly follow said other step or one or more intermediate steps may be carried out before carrying out the particular step, unless specified otherwise. Likewise it will be understood that when a connection between structures or components is described, this connection may be established directly or through intermediate structures or components unless specified otherwise.

As described herein, an additional (insulation) layer may be used to provide only local poling of the piezoelectric material and prevents lateral through-substrate acoustic crosstalk. The lateral dimensions of the vibrating membrane can be determined by the overlap between the top and bottom electrode sandwiching the active piezoelectric polymer. By inserting an additional dielectric between the electrodes that is locally patterned, the active device area is determined by the shape of the additional dielectric rather than the shape of the metal electrodes. In some embodiments, the additional dielectric film can be deposited directly before or after the piezoelectric film. The additional dielectric film is patterned

In some embodiments, structured metallic electrodes are processed on top of a plastic substrate. Onto the structured electrodes, a large-area piezoelectric layer is deposited. The resonance frequency of the membranes scales with diameter, and for higher frequencies increasingly smaller membranes may be used. For ease of fabrication a larger area of piezoelectric material, e.g. polymer P(VDF-TrFE) is preferred compared to the small membrane dimensions. By applying first a thicker dielectric layer on top of the piezoelectric material, for example with a thick photoresist, the membrane dimensions can be mechanically defined (pinned) to the edge of this structured layer. That means that even at high deflection of the membrane during vibration (at high driving voltages and/or at resonance) the membrane dimensions can remain fixed. As a last step the second electrode can be applied. This electrode can be structured per device or a common electrode shared between devices. Both electrodes are in touch with the piezoelectric only at the designated contact location in the hole in the structured stabilizing interlayer.

In some embodiments, a structure with the following sequence of layers can be used: electrode/piezoelectric/patterned insulator/electrode. In other embodiments the following sequence can be used: electrode/ patterned insulator/piezoelectric/electrode. Yet further embodiment may be similar but with the addition of a thin patterned protective layer between the patterned insulator and piezoelectric (e.g. SiN, SiO2, AlOx) to avoid contamination and subsequent degradation of the piezo electric material due to the patterned insulator. In some embodiments, the flexible substrate/support layer can be part of the vibrating membrane. To prevent acoustic crosstalk in-plane through this support layer, the membrane can be mechanically isolated, e.g. by providing the insulated regions with much higher bending stiffness (flexural rigidity) compared to the contact areas.

The invention is described more fully hereinafter with reference to the accompanying drawings, in which embodiments of the invention are shown. In the drawings, the absolute and relative sizes of systems, components, layers, and regions may be exaggerated for clarity. Embodiments may be described with reference to schematic and/or cross-section illustrations of possibly idealized embodiments and intermediate structures of the invention. In the description and drawings, like numbers refer to like elements throughout. Relative terms as well as derivatives thereof should be construed to refer to the orientation as then described or as shown in the drawing under discussion. These relative terms are for convenience of description and do not require that the system be constructed or operated in a particular orientation unless stated otherwise.

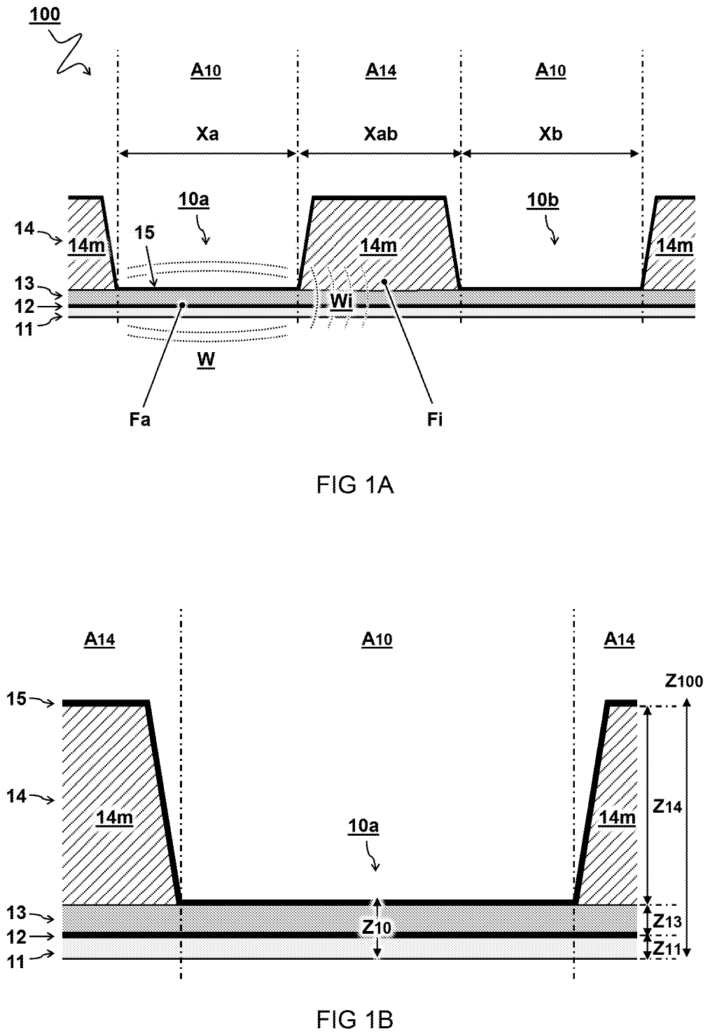

FIG. 1A illustrates a cross-section view of adjacent acoustic transducers 10a, 10b; FIG. 1B illustrates further details of one of the transducers 10a.

In a preferred embodiment, e.g. as shown, the acoustic device 100 comprises an array of acoustic transducers 10a, 10b. In another or further embodiment, the array is formed by a patterned stack 12-15 on a flexible substrate 11. In some embodiments, the stack comprises a piezoelectric layer 13 sandwiched between respective bottom and top electrode layers 12,15. In other or further embodiments, the stack comprises an insulation layer 14. Preferably, the insulation layer 14 is patterned. For example, the patterned insulation layer 14 is formed by a pattern of insulation material 14m.

In a preferred embodiment, e.g. as shown, the patterned insulation layer (14) comprises insulated areas A14 where the insulation material 14m is disposed between one of the electrodes 12,15 and the piezoelectric layer 13 (in a direction Z transverse to the substrate 11). In another or further preferred embodiment, the patterned insulation layer (14) comprises contact areas A10 without the insulation material 14m where both electrodes 12,15 contact the piezoelectric layer 13. More preferably, the acoustic transducers 10a, 10b are formed at the contact areas A10. For example, the acoustic transducers 10a, 10b are formed between the insulated areas A14. Most preferably, the insulated areas A14 surround and/or separate the respective contact areas A10. In other words the pattern of the insulation material 14m may define boundaries around the acoustic transducers 10a, 10b, where the contact areas A10 are formed at gaps in the pattern without any insulation material 14m between the piezoelectric layer 13 and either of the electrodes 12,15.

In a preferred embodiment, e.g. as shown, an actuation surface of the acoustic transducers 10a, 10b includes part of the flexible substrate 11 at the contact areas A10. In other words, a respective acoustic transducer 10a can be formed by a stack comprising the flexible substrate 11 with the piezoelectric layer 13 sandwiched between respective bottom and top electrode layers 12,15, but without the insulation material 14m at that area, i.e. the contact areas A10.

Preferably, the substrate 11 has relatively high flexibility, e.g. at least sufficient to bend or flex with the piezoelectric layer 13 for generating acoustic waves W, as intended. Typically, a first flexural rigidity of the substrate 11 (by itself, without the stack) can be on the same order as a second flexural rigidity of the stack of layers to be provided on the substrate 11 as part of the transducer (i.e. excluding the insulation material 14m). For example, the first flexural rigidity is between a factor 0.1-10 times the second flexural rigidity. Alternatively, or additionally, this may be quantified in that the (first) flexural rigidity (of the substrate) constitutes less than ninety percent of the total flexural rigidity Fa of the device at the contact areas A10, i.e. sum of the first and second flexural rigidities.

In a preferred embodiment, the substrate 11 need not be removed and can remain part of the acoustic device 100. In another embodiment, (not shown), the stack may be removed from a substrate on which it is manufactured, which may be the flexible substrate or another support substrate. For example, the patterned insulation material 14m may provide sufficient structural integrity to support the device without the substrate. This may allow e.g. also the use of a relatively rigid substrate to keep the structure fixed during manufacturing.

In a preferred embodiment, the acoustic device 100 is relatively flat, e.g. formed as a sheet. So, preferably a total thickness Z100 transverse to a plane of the acoustic device 100 is relatively small compared to an extent of its (smallest) in-plane dimension (diameter or length/width). For example, the in-plane dimension is more than the thickness by at least a factor ten, twenty, fifty, hundred, thousand, or more. For example, the total thickness (Z100) of the substrate 11, the piezoelectric layer 13 with electrodes 12,15, and the insulated areas A14 can be less than a millimeter, less than half a millimeter, e.g. between hundred and two hundred micrometer.

To effectively alleviate cross-talk, e.g. in-plane waves Wi, between the acoustic transducers 10a, 10b, it is desirable to decouple and/or dampen their respective vibrations. For example, decoupling can be achieved by providing areas of the substrate separating the transducers with different wave propagation characteristics than the areas forming the transducers. For example, dampening can be achieved by providing more and/or different (e.g. dissipative) types of material in the areas between the transducers.

One way to characterize the different areas of a relatively flat acoustic device 100 is by their respective flexural rigidity (F) or bending stiffness. For example, the flexural rigidity (F) of a layer or stack may depend on its Young's modulus (E), Poisson's ratio (v) and thickness (Z). Typically, this can be written as F=[E·Z³]/[12·(1−v²)]. In a preferred embodiment, a flexural rigidity Fx at the insulating areas A14 including the insulation layer 14 is higher than a flexural rigidity Fa at the contact areas A10 forming the acoustic transducers 10a, 10b by a least a factor ten, more preferably at least a factor twenty, most preferably at least a factor fifty, e.g. a factor between sixty and two hundred. The higher the relative flexural rigidity of the insulated areas, the more in-plane crosstalk between neighboring transducers can be alleviated.

The relatively high flexural rigidity of the insulated areas A14 can be provided by using an insulation material 14m with relatively high Young's modulus, e.g. higher than the Young's modulus of the flexible substrate 11. Alternatively, or additionally, a layer thickness Z14 of the insulation material 14m can be relatively high. In a preferred embodiment, the insulated areas A14 provide a locally increased thickness Z14 to the stack compared to the contact areas A10. For example, a thickness Z100 of the stack at the insulated areas A14 (e.g. equal to Z11+Z13+Z14) is higher than a thickness Z10 of the stack at the contact areas A10 (e.g. equal to Z11+Z13) by at least a factor two, preferably at least a factor three.

In an example fabricated device, the substrate 11 was formed by a polyimide (PI) substrate having thickness Z11=13.5 μm. On the substrate, the piezoelectric layer 13 was formed by a PVDF stack having thickness Z13=20 μm. The flexural rigidity of the device 100 at the area A10 (i.e. the substrate+piezoelectric layer) is estimated at Fa=1.35E−5 N·m (=Pa·m³). At the insulated areas A14, an additional layer of insulation material 14m was deposited before applying the top electrode 15. Specifically, the insulation material 14m was formed by a layer of photoresist (SU8) having thickness Z14=125 μm. Including this additional layer, the flexural rigidity of the device 100 at the areas A14 is estimated at Fi=1.19E−3 N·m. i.e. a factor 88 higher than the areas A10.

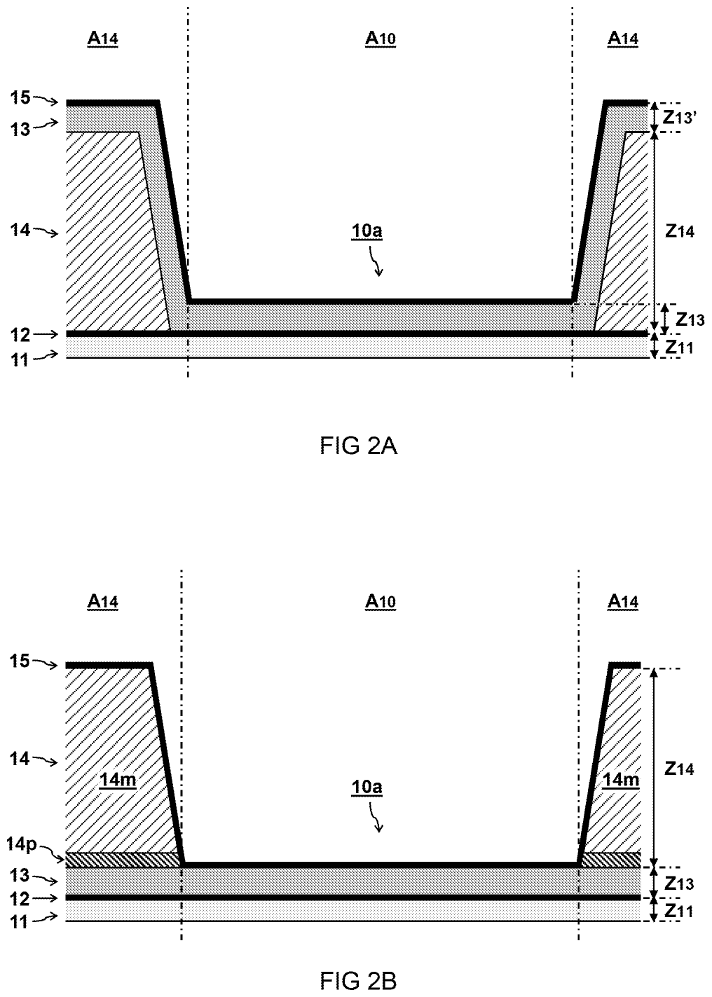

FIG. 2A illustrates a cross-section of an acoustic device 100 wherein the insulation material 14m is applied between the bottom electrode 12 and the piezoelectric layer 13. This is in contrast e.g. with the embodiment of FIGS. 1A and 1B, wherein the insulation material 14m is applied between the piezoelectric layer 13 and the top electrode 15. In a preferred embodiment, the insulation material is formed by a photoresist material. Such material may further improve manufacturability, e.g. providing an easy way to define the pattern of insulation material 14m by a corresponding light pattern/mask to develop the photoresist. In some embodiments, it may be envisaged that the patterning of the insulation material 14m can affect the piezoelectric layer 13. For example, the photoresist material and/or method of (selectively) removing the photoresist at the contact areas A10 by processes such as wet etching. In some embodiments, e.g. as shown, this may be alleviated by applying the insulation material 14m before the piezoelectric layer 13.

FIG. 2B illustrates a cross-section of an acoustic device 100 with an intermediate protection layer 14p. In some embodiments, an intermediate protection layer 14p is disposed between the piezoelectric layer 13 and the insulation material 14m. This may be used alternatively, or additionally, to protect the piezoelectric layer 13 from exposure, e.g. to the insulation material 14m (photoresist) and/or method of removal thereof. In this way, the piezoelectric layer 13 may still be applied before the patterning of the layer of insulation material 14m. Typically, the protection layer 14p may have a different material than the insulation material 14m. For example, the protection layer 14p may be more resistant to an etching process for removing the insulation material 14m. Preferably, the intermediate protection layer 14p is thereafter locally removed at the contact areas A10. e.g. using another process (than was used for removing the photoresist), such as dry etching (gas). In principle, the protection layer 14p can act in addition to the insulation material 14m as part of the electrical insulation between the respective electrode and piezoelectric layer and/or as part of the acoustic insulation between neighboring transducers. In that sense, both layers 14m and 14p can be considered part of the patterned insulation material.

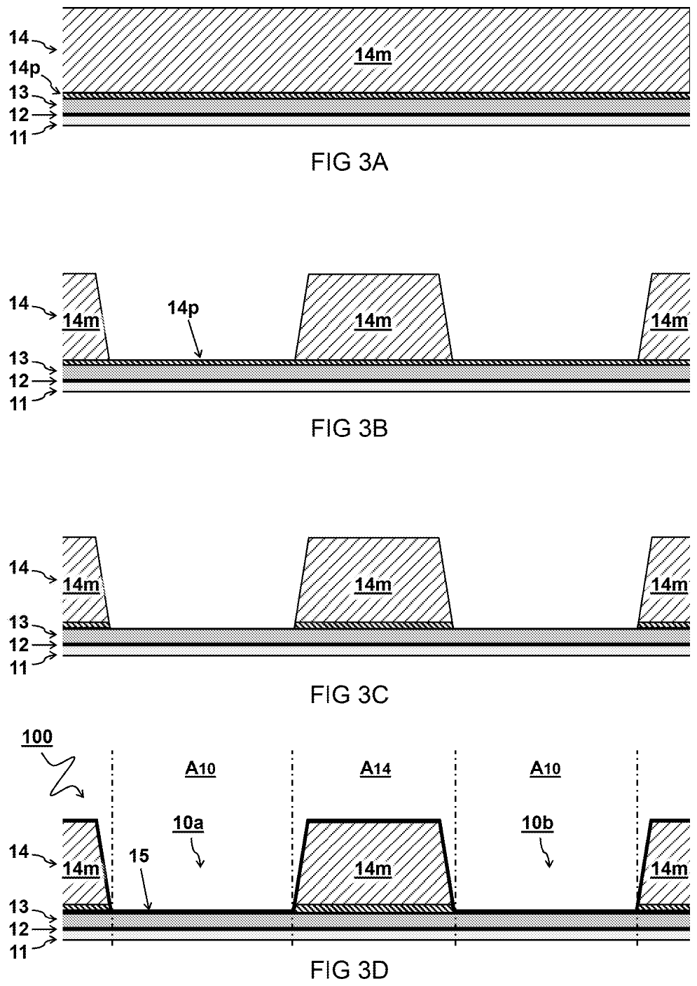

FIGS. 3A-3D illustrate a method of manufacturing an acoustic device 100.

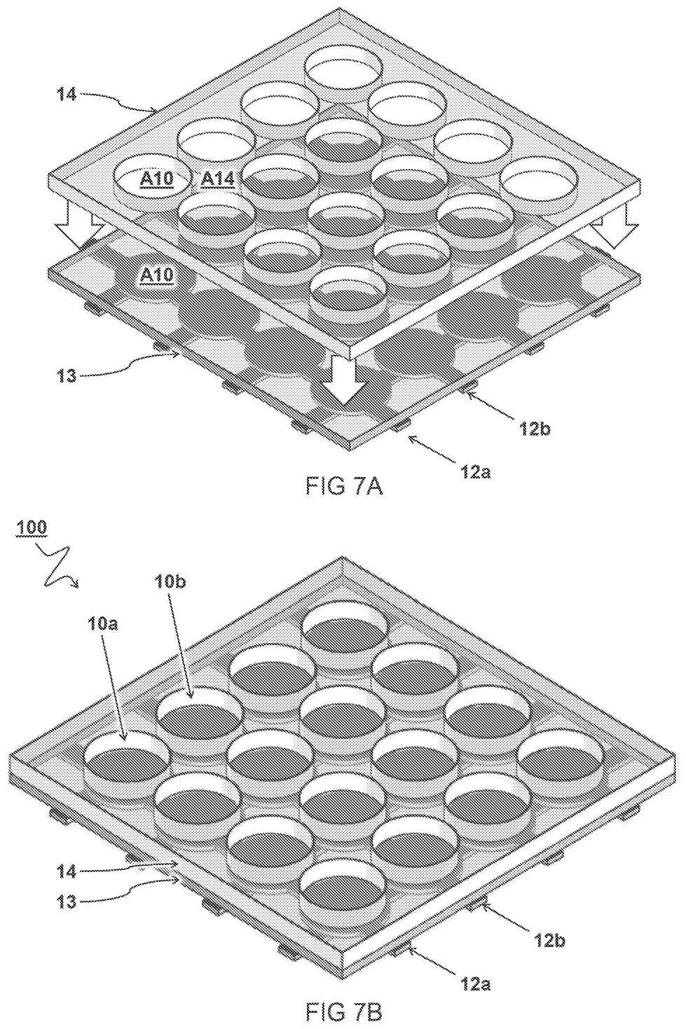

In one embodiment, as shown e.g. in FIG. 3A, the method comprises providing a stack formed on a flexible substrate 11. Preferably, the stack (initially) comprises at least a bottom electrode 12. In some embodiments, e.g. as shown in FIGS. 3A and 3B, a layer of insulation material 14m is deposited onto the stack and selectively removed. The places where the insulation material 14m is removed will form the contact areas A10 for electrical contact through the stack with the bottom electrode 12. Alternatively to removing the material after depositing, a pre-patterned layer of insulation material, e.g. foil with openings, may be applied to the stack (e.g. shown in FIG. 7A).

In some embodiments, e.g. shown in FIG. 3D, a top electrode 15 onto the stack to form an array of acoustic transducers 10a, 10b at the contact areas A10 where both the top and bottom electrodes contact a piezoelectric layer 13 there between, which piezoelectric layer 13 is deposited onto the stack before or after the depositing the layer of insulation material 14m, wherein the acoustic transducers 10a, 10b are separated by insulated areas A14 where the insulation material 14m is disposed between one of the electrodes 12,15 and the piezoelectric layer 13.

In some embodiments, the insulation material 14m comprises a photoresist material. In other or further embodiments, the patterned insulation layer 14 is formed by a lithographic process. For example, the unpatterned layer of insulation material 14m is exposed to a light pattern matching the shape of the contact areas A10 or the shape of the insulated areas A14. For example, a mask is used to provide the patterned exposure. It will be appreciated that lithograph can be used to easily form a desired high precision patterns of acoustic transducers, e.g. at relatively small dimensions and/or large numbers.

In some embodiments, e.g. as shown in FIG. 3A, a protection layer 14p is provided between the piezoelectric layer 13 and insulation layer 14. For example, as shown in FIG. 3B, the protection layer 14p can remain when removing the insulation material 14m to protect the piezoelectric layer 13 against a removal process for patterning the insulation layer 14, e.g. wet etching. In some embodiments, e.g. as shown in FIG. 3C, the protection layer 14p may be removed at the contact areas A10 by a separate process, e.g. dry etching. Accordingly, as shown e.g. in FIG. 3D, the top electrode layer 15 can be deposited on the piezoelectric layer 13 without the protection layer 14p there between.

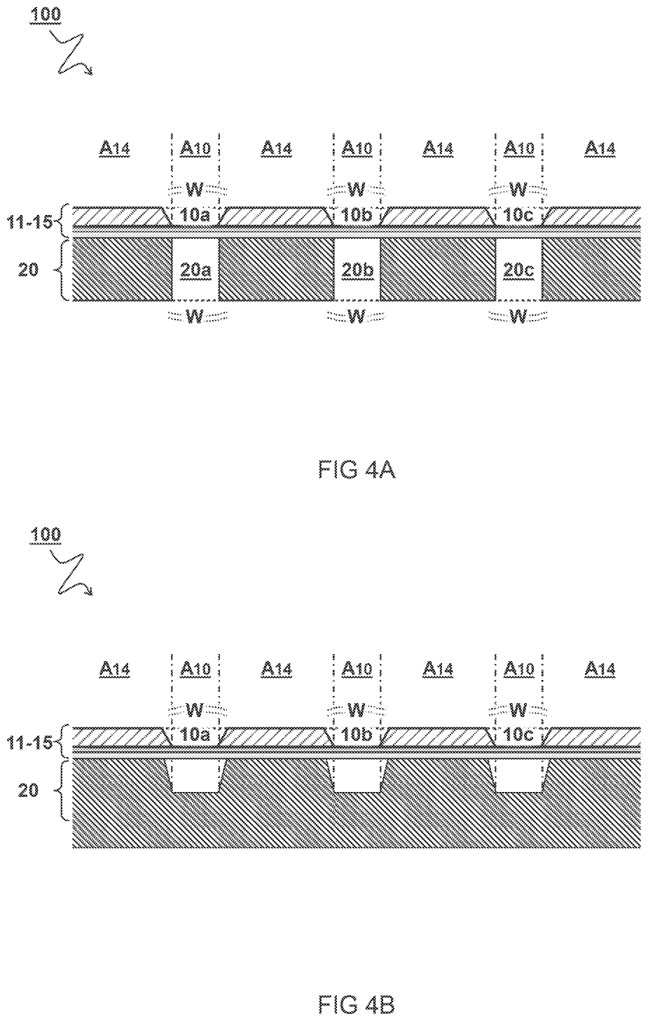

FIGS. 4A and 4B illustrate an acoustic device 100 with the flexible substrate 11 fixed to a support structure 20.

In some embodiments, e.g. as shown, the flexible substrate 11 is fixed, e.g. laminated, or otherwise disposed on a relatively rigid support substrate 20. For example, the substrate 11 can be laminated and/or otherwise adhered to the support substrate 20. The fixation between the flexible substrate and the support substrate or other rigid structure may be provided e.g. during and/or after manufacturing. The support substrate can be relatively flat similar or thicker compared to the flexible substrate 11. Preferably, the support substrate 20 has a relatively high flexural rigidity compared to the flexible substrate 11, e.g. higher by at least a factor two, three, five, ten, or more. Accordingly, the support substrate 20 may provide additional structural integrity.

Preferably, the support substrate 20 is provided with openings 20a-20c at positions corresponding to the acoustic transducers 10a-10c, i.e.

at least partially overlapping the contact areas A10. For example, the flexible substrate 11 abuts the support structure at the insulated areas A14 while it is not connected to the support structure 20 at the contact areas A10. In some embodiments, the openings 20a-20c may extend through the support substrate 20, e.g. as shown in FIG. 4A. In other or further embodiments, the openings 20a-20c may be formed by cavities concavely extending from the direction of the flexible substrate 11 but not completely through the support substrate 20. The openings may allow relatively free movement of the transduced surfaces while still providing a rigid support. Additionally, the fixation of the insulated areas A14 to the support structure may help to provide even further acoustic insulation between the transducers 10a, 10b. In some embodiments (not shown), a support substrate may be provided at the top side, e.g. after depositing completing the stack. Also combinations are possible with support structures on one or both sides, preferably with through openings such as shown in FIG. 4A, at least on one side to transmit the acoustic waves W.

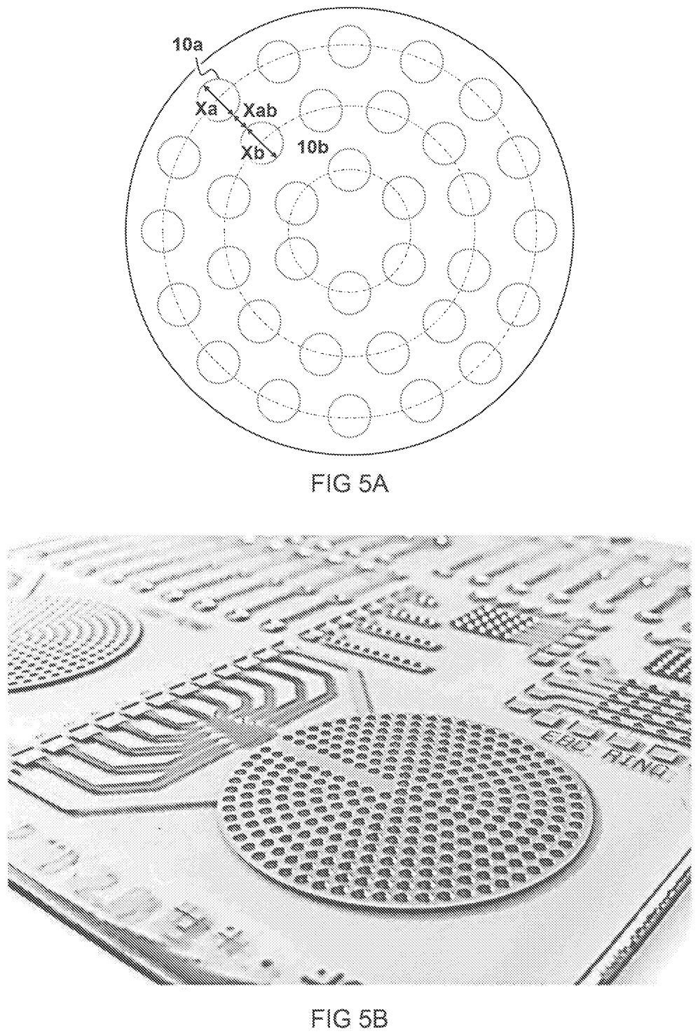

FIG. 5A illustrates a transducer array according to an example layout. FIG. 5B shows a photograph of a device with similar layout.

In some embodiments, e.g. as shown, the centers of the transducers may be arranged along a plurality of concentric circles. Accordingly each of the transducers along a respective circle may have the same distance with respect to a point along a central axis of the circles transverse to a plane of the device. By actuating a first set of transducers along a respective first circle in phase, acoustic waves of those transducers may constructively interfere at points along the central axis. By additionally actuating a second set of transducers along a respective second circle also in phase within the first set, but with a predetermined phase difference with respect to the first set, an specific point can be selected above a surface of the device at which constructive interference occurs between the sets. This can be further improved by additional sets. In one embodiment, the device shown can be used to create a haptic feedback device which creates a tangible point in mid-air by the constructive interference between many transducers. For example, the location of the point can be controlled by controlling the relative phases between the sets of transducers (along the central axis), or within the respective sets (to move the point off-axis). Of course, also other layouts can be used to create similar or other acoustic devices, e.g. a grid layout.

It will be appreciated that, by the effective decoupling as described herein, a lateral spacing or distance Xab between the neighboring transducers 10a, 10b in any layout can be relatively small, e.g. on the same order as a (maximum or average) diameter Xa,Xb of the transducers 10a, 10b. For example, the (minimum) distance Xab between the transducers is between 0.1-10 times the (constant or average) diameter Xa,Xb of the transducers, preferably between 0.2-5 times, more preferably, between half and two times. In some embodiments, a density of the transducers over the surface of the device can be relatively high, e.g. the transducers may cover at least ten percent of the surface (the remaining surface formed by the areas between the transducers), preferably at least twenty percent, more preferably at least thirty percent, or even more than fifty percent. The more of the surface can be covered by the transducers, the more effective can the device operate.

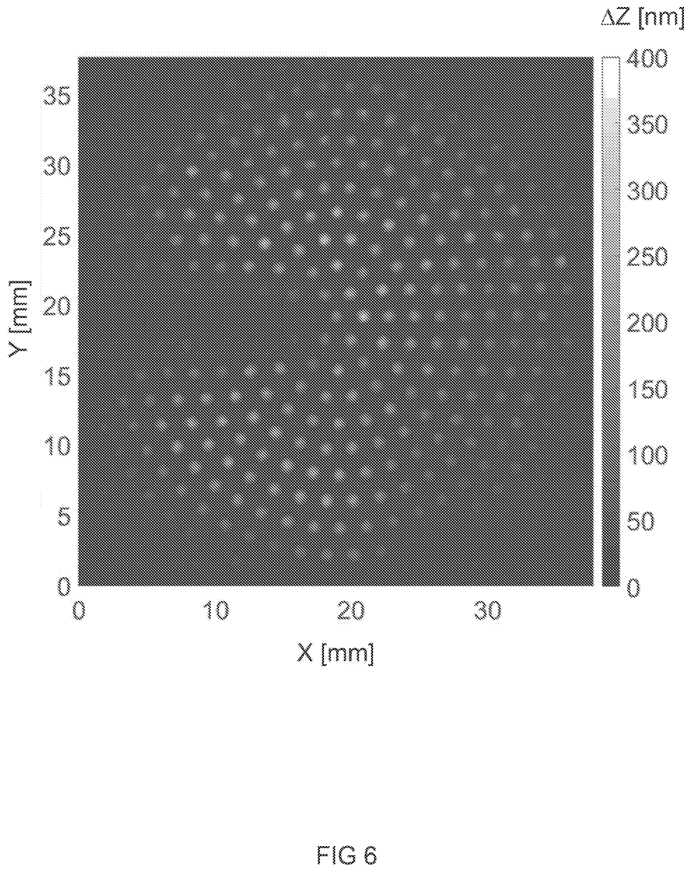

FIG. 6 illustrates a measurement of a deflection ΔZ (in nanometers) over a surface X,Y of an acoustic device, such as shown in FIG. 5B, where the transducers are actuated. The measurement was performed using a laser vibrometer. As shown, the deflection ΔZ is limited to the contact areas of the transducers, while there is virtually no noticeable deflection at the insulated areas between the transducers, e.g. the deflection at the insulated areas is at least a factor ten less than the deflection at the contact areas.

FIGS. 7A and 7B illustrate another layout of acoustic transducers 10a, 10b. In one embodiment, e.g. as shown in FIG. 7A, the insulation layer 14 is pre-patterned before being applied to the stack. Alternatively, the insulation layer 14 shown in FIG. 7B may be patterned by selective removal of material as was described e.g. with reference to FIGS. 3A-3D.

In a preferred embodiment, the piezoelectric layer 13 is a continuous layer extending between different transducers 10a, 10b. Advantageously, it may be much easier to deposit the piezoelectric material as a continuous layer. Preferably, a polymer based piezoelectric material is used for the piezoelectric layer 13. For example, polymer based piezoelectric material can be easily applied as a continuous layer. In some embodiments, the deposited piezoelectric material may initially have domains that are randomly oriented. Preferably, these are aligned by “poling” the piezoelectric material, i.e. a process by which a strong electric field is applied across the material, usually at elevated temperatures. Most preferably, the piezoelectric layer 13 is exclusively (or predominantly) poled at the contact areas A10. For example, the strong electric field for poling is applied via the bottom electrode 12 and top electrode (not visible here). Due to the patterned insulation layer 14, a voltage difference between the electrodes may result in an electric field which is stronger across the piezoelectric layer 13 at the contact areas A10 than across the larger gap of the insulated areas A14. As will be appreciated, the selective poling may also help to improve functionality, e.g. further prevent actuation of the piezoelectric layer 13 at the non-poled regions of the insulated areas A14.

In some embodiments, at least one of the bottom and top electrodes is a continuous layer extending between different transducers 10a, 10b. In other or further embodiments, at least one of the electrodes 12,15 is patterned. In one embodiment, a combination of a patterned and unpatterned electrode layer is used. Preferably, the patterning of the electrodes is such that subsets of one or more of the acoustic transducers 10a, 10b can be selectively actuated. In one embodiment, a first set of one or more transducers 10a is actuated by applying a voltage to a first line 12a of the bottom electrode, and a different, second set of one or more transducers 10b is actuated by applying a voltage to a different, second line 12a of the bottom electrode. In some embodiments, e.g. as shown, the lines 12a, 12b may comprise contact pads shaped to cover at least the contact areas A10. Alternatively, or in addition to the bottom electrode being patterned, the top electrode may be patterned (not shown). In some embodiments (not shown), the pattern of the top electrode may complement the pattern of the bottom electrode, e.g. forming perpendicular grid lines. In other or further embodiments, e.g. as shown, a grid of electrode lines may be formed on one side of the piezoelectric layer 13. For example, the grid may comprise thin film transistors (TFT).

For the purpose of clarity and a concise description, features are described herein as part of the same or separate embodiments, however, it will be appreciated that the scope of the invention may include embodiments having combinations of all or some of the features described. For example, while embodiments were shown for specific sequences of layers, also alternative ways may be envisaged by those skilled in the art having the benefit of the present disclosure for achieving a similar function and result. For example, some layers may be combined or split up into one or more alternative layers. The various elements of the embodiments as discussed and shown offer certain advantages, such as isolating lateral vibrations. Of course, it is to be appreciated that any one of the above embodiments or processes may be combined with one or more other embodiments or processes to provide even further improvements in finding and matching designs and advantages. It is appreciated that this disclosure offers particular advantages to acoustic transducer arrays, and in general can be applied to form other electrical components between selective contact areas formed by an insulating layer selectively separating electrode layers.

In interpreting the appended claims, it should be understood that the word “comprising” does not exclude the presence of other elements or acts than those listed in a given claim; the word “a” or “an” preceding an element does not exclude the presence of a plurality of such elements; any reference signs in the claims do not limit their scope; several “means” may be represented by the same or different item(s) or implemented structure or function; any of the disclosed devices or portions thereof may be combined together or separated into further portions unless specifically stated otherwise. Where one claim refers to another claim, this may indicate synergetic advantage achieved by the combination of their respective features. But the mere fact that certain measures are recited in mutually different claims does not indicate that a combination of these measures cannot also be used to advantage. The present embodiments may thus include all working combinations of the claims wherein each claim can in principle refer to any preceding claim unless clearly excluded by context.

1. An acoustic device comprising an array of acoustic transducers formed by a patterned stack on a flexible substrate, wherein the stack comprises:
a continuous piezoelectric layer that extends between different ones of the acoustic transducers and is sandwiched between a bottom electrode layer and a top electrode layer; and
a patterned insulation layer formed by a pattern of an insulation material, wherein the pattern comprises:
insulated areas where the insulation material is disposed between:
an electrode that is from one of the bottom electrode layer and the top electrode layer, and
the piezoelectric layer; and
contact areas without the insulation material and where both the bottom electrode layer and the top electrode layer contact, from opposite sides, the piezoelectric layer.

2. The acoustic device according to claim 1, wherein an actuation surface of the acoustic transducers includes part of the flexible substrate at the contact areas.

3. The acoustic device according to claim 1, wherein a total combined thickness of the flexible substrate, the piezoelectric layer with electrodes, and the insulated areas is less than a millimeter.

4. The acoustic device according to claim 3, wherein a thickness of the stack at the insulated areas is greater than a thickness of the stack at the contact areas by at least a factor of two.

5. The acoustic device according to claim 1, wherein a flexural rigidity at the insulating areas including the patterned insulation layer is greater than a flexural rigidity at the contact areas forming the acoustic transducers by at least a factor of ten.

6. The acoustic device according to claim 1, wherein the insulation material is disposed between the piezoelectric layer and the top electrode layer.

7. The acoustic device according to claim 1, wherein the insulation material comprises a photoresist material.

8. The acoustic device according to claim 1, wherein an intermediate protection layer is disposed between the piezoelectric layer and the insulation material, and wherein the protection layer is resistant to an etching process for removing the insulation material.

9. The acoustic device according to claim 1, wherein a distance between nearest neighbor transducers is between a half of and two times a diameter of the nearest neighbor transducers.

10. The acoustic device according to claim 1, wherein the piezoelectric layer is exclusively poled at the contact areas.

11. The acoustic device according to claim 1, wherein one of the bottom electrode layer and the top electrode layer is a continuous layer extending between different transducers, and the other of the bottom electrode layer and the top electrode layer is patterned for controllably actuating different subsets of the transducers.

12. The acoustic device according to claim 1, wherein the acoustic device forms a haptic feedback device, wherein the transducers are arranged along a plurality of concentric circles configured to create a tangible point in mid-air above the device along a centerline of the concentric circles by constructive interference between acoustic waves emitted by the transducers of different concentric circles.

13. The acoustic device according to claim 1, wherein the flexible substrate is fixed on a rigid support substrate, wherein a flexural rigidity of the rigid support substrate is higher than a flexural rigidity of the flexible substrate by at least a factor of two.

14. The acoustic device according to claim 13, wherein the support substrate is provided with openings at positions corresponding to the acoustic transducers.

15. A method of manufacturing an acoustic device, the method comprising providing a stack formed on a flexible substrate, the stack comprising at least a bottom electrode;
depositing a layer of insulation material onto the stack and selectively removing the insulation material to form contact areas between remaining parts of the insulation material;
depositing a continuous piezoelectric layer onto the stack so that piezoelectric material of the continuous piezoelectric layer contacts the bottom electrode at least at the contact areas; and
depositing a top electrode onto the stack to form a plurality of acoustic transducers at the contact areas where both the top electrode layer and the bottom electrode layer contact the continuous piezoelectric layer sandwiched there between,
wherein the continuous piezoelectric layer extends between a first acoustic transducer contact area and a second acoustic transducer contact area of the contact areas of the plurality of acoustic transducers,
wherein the first acoustic transducer contact area is separated from the second acoustic transducer contact area by an insulated area,
wherein the insulated area includes an insulating layer structure wherein the insulation material is disposed between:
one of either the bottom electrode layer and the top electrode layer electrode, and
the continuous piezoelectric layer.

16. The method according to claim 15, wherein an actuation surface of the acoustic transducers includes part of the flexible substrate at the contact areas.

17. The method according to claim 15, wherein a total thickness of the flexible substrate, the continuous piezoelectric layer with electrodes, and the insulated areas is less than a millimeter; and a thickness of the stack at the insulated areas is greater than a thickness of the stack at the contact areas by at least a factor of two.

18. The method according to claim 15, wherein a flexural rigidity at the insulating areas including the insulation layer is greater than a flexural rigidity at the contact areas forming the acoustic transducers by at least a factor of ten.

19. The method according to claim 15, wherein the insulation material is disposed between the continuous piezoelectric layer and the top electrode layer, wherein the insulation material comprises a photoresist material, wherein an intermediate protection layer is disposed between the continuous piezoelectric layer and the insulation material, and wherein the protection layer is resistant to an etching process for removing the insulation material.

20. The method according to claim 15, comprising selectively poling the acoustic device so as to perform poling the continuous piezoelectric layer at the contact areas and not perform poling the continuous piezoelectric layer at the insulated areas.
